(19) United States
(12) Patent Application Publication
(10) Pub. No.: US 2018/0119786 A1
(43) Pub. Date: May 3, 2018

(54) Continuously Variable Transmission Having A Ball-Type Continuously Variable Transmission

(71) Applicant: Dana Limited, Maumee, OH (US)

(72) Inventors: Shaun E. Mepham, Saline, MI (US); Joseph S. VanSelous, Kapaa, HI (US)

(21) Appl. No.: 15/858,154

(22) Filed: Dec. 29, 2017

Related U.S. Application Data
(60) Provisional application No. 62/577,278, filed on Oct. 26, 2017.

(51) Int. Cl. F16H 37/08; F16H 59/40; F16H 15/50; F16H 61/664; F16H 59/70; F16H 63/06

(52) U.S. Cl. CPC F16H 37/084; F16H 59/40; F16H 15/50; F16H 2061/6641; F16H 59/70; F16H 63/067; F16H 2037/0866; F16H 61/6645

(57) ABSTRACT

Devices and methods are provided herein for the transmission of power in motor vehicles. Power is transmitted in a smoother and more efficient manner by splitting torque into two or more torque paths. In some embodiments, a powertrain is configured to have a ball-type variator and two planetary gear sets. Clutches selectively engagement members of the variator to provide multiple modes of operation.

### RELATED APPLICATION

This application claims the benefit of U.S. Provisional Patent Application No. 62/577,278, filed Oct. 26, 2017, which is incorporated herein by reference in its entirety.

### BACKGROUND

A power converter including a continuously variable transmission allows an operator or a control system to vary a drive ratio in a stepless manner, permitting a power source to operate at its most advantageous rotational speed.

### SUMMARY

Provided herein is a powertrain including: an input shaft; a counter shaft aligned parallel to the input shaft; a variator aligned coaxially with the input shaft, the variator having a first plurality of balls, each ball provided with a tiltable axis of rotation, each ball in contact with a first traction ring assembly and a second traction ring assembly, and each ball operably coupled to a carrier assembly; a first planetary gear set arranged coaxially with the input shaft, the first planetary gear set having a first ring gear operably coupled to the first traction ring assembly, a first planet carrier supporting a set of dual pinion gears, the first planet carrier operably coupled to the input shaft, and a first sun gear coupled to the first planet carrier, the first sun gear operably coupled to the second traction ring assembly; a second planetary gear set arranged coaxially with the counter shaft, the second planetary gear set having a second ring gear, a second planet carrier supporting a second plurality of planet gears coupled to the second ring gear, the second planet carrier operably coupled to the second ring gear, a third planet carrier supporting a third plurality of planet gears, the third planet carrier operably coupled to the second ring gear, a second sun gear coupled to the second plurality of the planet gears, and a third sun gear coupled to the third plurality of planet gears; a first-and-second mode clutch coupled to the second sun gear, wherein the first-and-second mode clutch is configured to selectively couple to ground; a second-and-third mode clutch coupled to the second traction ring assembly, wherein the second-and-third mode clutch is configured to selectively couple to the second traction ring assembly to the counter shaft; a first-fourth-reverse mode clutch operably coupled to the counter shaft, the first-fourth-reverse mode clutch configured to selectively engage the first ring gear to the counter shaft; and a third-and-fourth mode clutch coupled to the third planet carrier, the third-and-fourth mode clutch configured to selectively engage the input shaft to the third planet carrier.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic of a multiple mode continuously variable transmission having a ball-type variator.

FIG. 5 is a table depicting operating modes of the transmission of FIG. 4.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiment. Furthermore, the preferred embodiments include several novel features, no single one of which is solely responsible for its desirable attributes or which is essential to practicing the inventions described.

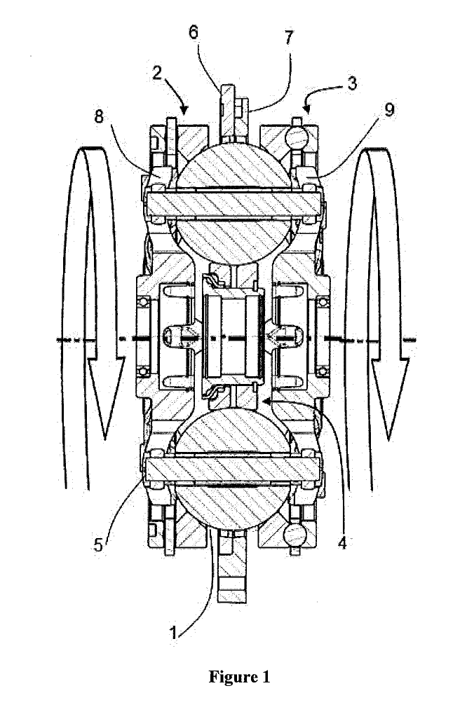

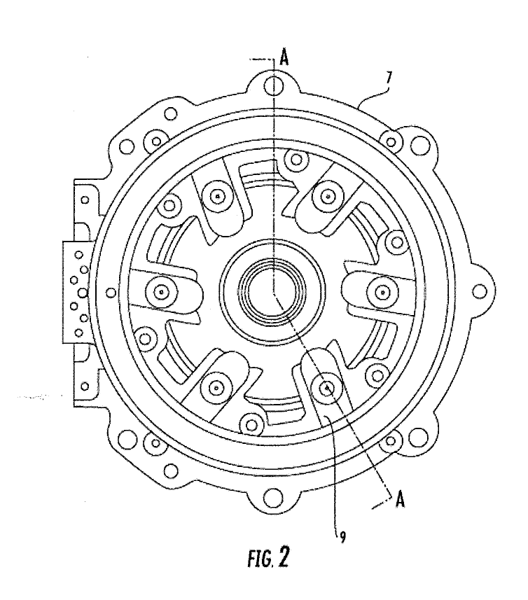

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, an input (first) 2 and output (second) 3, and an idler (sun) assembly 4 as shown on FIG. 1. Sometimes, the input ring 2 is referred to in illustrations and referred to in text by the label “R1”. The output ring is referred to in illustrations and referred to in text by the label “R2”. The idler (sun) assembly is referred to in illustrations and referred to in text by the label “S”. The balls are mounted on tiltable axles 5, themselves held in a carrier (stator, cage) assembly having a first carrier member 6 operably coupled to a second carrier member 7. Sometimes, the carrier assembly is denoted in illustrations and referred to in text by the label “C”. These labels are collectively referred to as nodes (“R1”, “R2”, “S”, “C”). The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In some embodiments, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

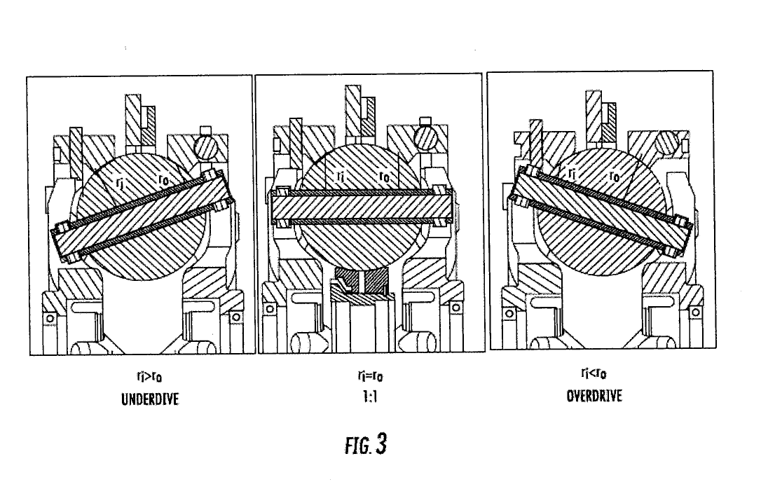

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. The preferred embodiments disclosed herein are related to the control of a variator and/or a CVT using generally spherical planets each having a tiltable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling is capable of taking a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these will be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here are capable of operating in both tractive and frictional applications. For example, in the embodiment where a CVT is used for a bicycle application, the CVT operates at times as a friction drive and at other times as a traction drive, depending on the torque and speed conditions present during operation.

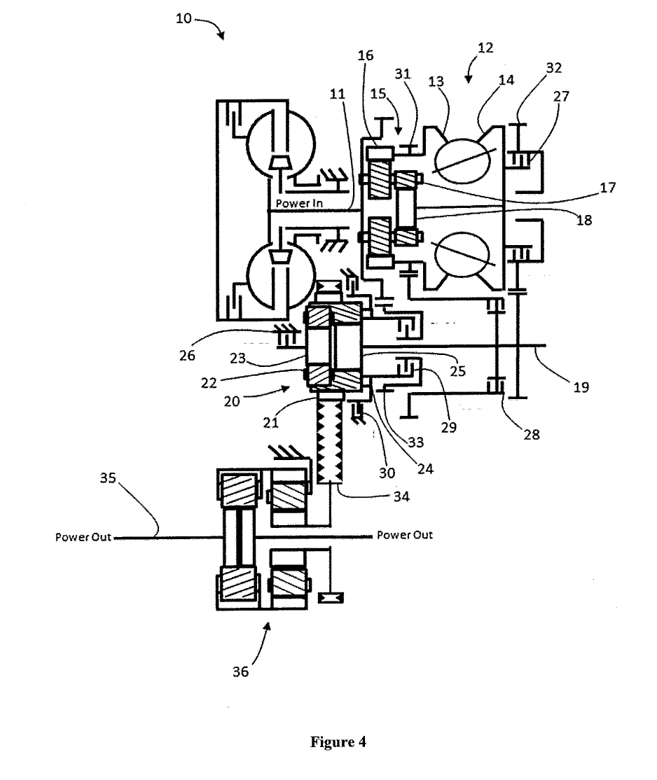

Referring now to FIG. 4, in some embodiments, a powertrain 10 is provided with an input shaft 11 adapted to receive a power from a source of rotational power or other coupling such as a torque converter. The powertrain 10 includes a variator (CVP) 12 such as the one described in FIGS. 1-3. The CVP 12 includes a first traction ring assembly 13 and a second traction ring assembly 14. In some embodiments, the powertrain 10 is provided with a first compound planetary gear set 15 of the simpson type having a first ring gear 16, a first planet carrier 17 adapted to support a dual pinion gear set, and a first sun gear 18. In some embodiments, the first planet carrier 17 is coupled to the input shaft 11. The first sun gear 18 is coupled to the second traction ring assembly 14. The first ring gear 16 is operably coupled to the first traction ring assembly 13. The CVP 12 and the compound planetary gear 15 are coaxial with the input shaft 11. The powertrain 10 is provided with a counter shaft 19 aligned parallel with the input shaft. The counter shaft 10 is operably coupled to a second compound planetary gear set 20 of the ravigneaux type having a second ring gear 21, a second planet carrier 22, a second sun gear 23, a third planet carrier 24, and a third sun gear 25. The third sun gear is coupled to the counter shaft 19. The powertrain 10 includes a first-and-second mode clutch 26 operably coupled to the second sun gear 23 and configured to selectively couple to a grounded member of the powertrain 10, such as a housing (not shown). The powertrain 10 includes a second-and-third mode clutch 27 operably coupled to the second traction ring assembly 14. In some embodiments, the second-and-third mode clutch 27 selectively engages the second traction ring assembly 14 to the counter shaft 19 through a first transfer gear set 32. The powertrain 10 includes a first-fourth-reverse mode clutch 28 operably coupled to the counter shaft 19. In some embodiments, the first-fourth-reverse mode clutch 28 is configured to selectively engage the first ring gear 16 to the counter shaft 19 through a second transfer gear 31. The powertrain 10 includes a third-and-fourth mode clutch 29 operably coupled to the third planet carrier 24. The third-and-fourth mode clutch 29 is configured to selectively engage the input shaft 11 to the third planet carrier 24 through a third transfer gear 33. In some embodiments, the powertrain 10 includes a reverse clutch 30 coupled to the third planet carrier 24. The reverse clutch 30 is configured to selectively engage a grounded member of the powertrain 10, such as a housing. In some embodiments, the second compound planetary gear set 20 is coupled through a chain drive to an output shaft 35 through a final drive gear set 36. The output shaft 35 is parallel to the counter shaft 19. In some embodiments, the final drive gear set 36 is coupled to an axle.

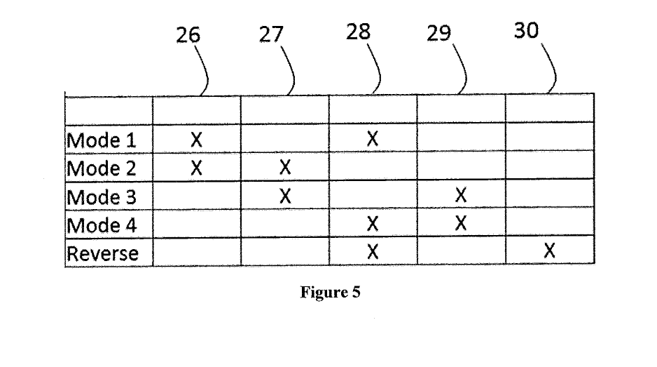

Referring to FIG. 5, during operation of the powertrain 10, multiple modes of operation is achieved through the engagement and disengagement of the clutches provided in the powertrain 10. For example, a first mode of operation corresponds to engagement of the first-and-second mode clutch 26 and the first-fourth-reverse mode clutch 28 while the other clutches are disengaged. A second mode of operation having a higher speed range than the first mode of operation, corresponds to the engagement of the first-and-second mode clutch 26, the second-and-third mode clutch 27, and the first-fourth-reverse mode clutch 28. A third mode of operation having a higher speed range than the second mode, corresponds to the engagement of the second-and-third mode clutch 27 and the third-and-fourth mode clutch 29. A fourth mode of operation having a higher speed range than the third mode of operation, corresponds to the engagement of the first-fourth-reverse clutch 28 and the third-and-fourth clutch 29. A reverse mode of operation corresponds to engagement of the first-fourth-reverse clutch 28 and the reverse clutch 30.

While the preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the preferred embodiments described herein are capable of being employed in practicing the invention. It is intended that the following claims define the scope of the invention and that methods and structures within the scope of these claims and their equivalents be covered thereby.

What is claimed is:

1. A powertrain comprising:
an input shaft;
a counter shaft aligned parallel to the input shaft;
a variator aligned coaxially with the input shaft, the variator having a first plurality of balls, each ball provided with a tiltable axis of rotation, each ball in contact with a first traction ring assembly and a second traction ring assembly, and each ball operably coupled to a carrier assembly;
a first planetary gear set arranged coaxially with the input shaft, the first planetary gear set having a first ring gear operably coupled to the first traction ring assembly, a first planet carrier supporting a set of dual pinion gears, the first planet carrier operably coupled to the input shaft, a first sun gear coupled to the first planet carrier, and the first sun gear operably coupled to the second traction ring assembly;
a second planetary gear set arranged coaxially with the counter shaft, the second planetary gear set having a second ring gear, a second planet carrier supporting a second plurality of planet gears coupled to the second ring gear, the second planet carrier operably coupled to the second ring gear, a third planet carrier supporting a third plurality of planet gears, the third planet carrier operably coupled to the second ring gear, a second sun gear coupled to the second plurality of the planet gears, and a third sun gear coupled to the third plurality of planet gears;
a first-and-second mode clutch coupled to the second sun gear, wherein the first-and-second mode clutch is configured to selectively couple to ground;
a second-and-third mode clutch coupled to the second traction ring assembly, wherein the second-and-third mode clutch is configured to selectively couple to the second traction ring assembly to the counter shaft;
a first-fourth-reverse mode clutch operably coupled to the counter shaft, wherein the first-fourth-reverse mode clutch is configured to selectively engage the first ring gear to the counter shaft; and
a third-and-fourth mode clutch coupled to the third planet carrier, wherein the third-and-fourth mode clutch configured to selectively engage the input shaft to the third planet carrier.

2. The powertrain of claim 1, further comprising a reverse clutch coupled to the third planet carrier, the reverse clutch configured to selectively couple to ground.

3. The powertrain of claim 1, further comprising a torque converter coupled to the input shaft.

4. The powertrain of claim 1, further comprising a drive chain coupling the second planetary gear set to a final drive gear set.

5. The powertrain of claim 4, wherein the final drive gear set is coupled to an axle.

6. The powertrain of claim 1, further comprising a first transfer gear set coupling the second-and-third mode clutch to the counter shaft.

7. The powertrain of claim 1, further comprising a second transfer gear set coupling first ring gear to the counter shaft.

8. The powertrain of claim 1, further comprising a third transfer gear set coupling the input shaft to the third planet carrier.
